(19) United States
(12) Patent Application Publication
(10) Pub. No.: US 2024/0143455 A1
(43) Pub. Date: May 2, 2024

(54) VIRTUAL MACHINE BACKUP SYSTEM AND METHOD

(71) Applicant: INSTITUTE FOR INFORMATION INDUSTRY, Taipei City (TW)

(72) Inventors: Lee Chung CHEN, Taipei City (TW); Li Hao CHIANG, Taipei City (TW); Gin CHI, Taipei City (TW); Wei Jie HSU, Taipei City (TW); Jiann Wen WANG, Taipei City (TW); Wen Dwo HWANG, Taipei City (TW)

(73) Assignee: INSTITUTE FOR INFORMATION INDUSTRY, Taipei City (TW)

(21) Appl. No.: 18/197,582

(22) Filed: May 15, 2023

(30) Foreign Application Priority Data
Nov. 2, 2022 (TW) 111141793

(51) Int. Cl. G06F 11/14; G06F 9/455

(52) U.S. Cl. CPC G06F 11/1469; G06F 9/45558; G06F 2009/45562

(57) ABSTRACT

A virtual machine backup method, performed by a first host, includes: capturing a request to write data from a virtual machine to a hard disk image file, wherein the request includes written data and input and output location information, copying the written data to a temporary storage area, calculating a first key of the written data, storing the first key, the input and output location information into a first resource location structure, pausing an operation of the virtual machine and generating a second resource location structure according to the first resource location structure, the first key and a second key, and outputting a backup data set to a second host according to the second resource location structure, wherein the backup data set includes the second resource location structure and only one of existing data and the written data when the first key and the second key are the same.

### CROSS-REFERENCE TO RELATED APPLICATIONS

This non-provisional application claims priority under 35 U.S.C. § 119(a) on Patent Application No(s). 111141793 filed in Republic of China (ROC) on Nov. 2, 2022, the entire contents of which are hereby incorporated by reference.

### BACKGROUND

### 1. Technical Field

This disclosure relates to a virtual machine backup system and method.

### 2. Related Art

Various backup technologies are continuously developed and improved to provide system reliability and to uninterrupted service, especially for systems and hosts providing cloud computing services. With the support of said technologies, a virtual machine can be quickly transferred to a backup host to continue operation when a host experiences failure. The existing virtual machine will back up hard disk data, such as backing up computing resources of memory and host status to achieve the goal of complete virtual machine backup and data integrity.

However, after the protection for the backup host is activated and when the virtual machine writes data into an application (for example, a database) that is constantly storing data, the operating system and the cache mechanism of the application generate data with the same content but located at different addresses. Therefore, the backup host requires longer processing time and wider bandwidth for extra data copy, which leads to the increase in backup time and affects the performance of the application in the virtual machine.

### SUMMARY

Accordingly, this disclosure provides a virtual machine backup system and method.

According to one or more embodiment of this disclosure, a virtual machine backup method, performed by a first host, includes: capturing a request to write data from a virtual machine to a hard disk image file, wherein the request includes written data, input location information and output location information; copying the written data to a temporary storage area; calculating a first key of the written data; storing the first key, the input location information and the output location information into a first resource location structure; pausing an operation of the virtual machine and generating a second resource location structure according to the first resource location structure and a comparison result between the first key and a second key corresponding to the input location information, wherein the second key corresponds to existing data stored in the temporary storage area; and outputting a backup data set to a second host according to the second resource location structure for the second host to generate a duplicate of the virtual machine and a duplicate of the hard disk image file, wherein the backup data set includes the second resource location structure and only one of the existing data and the written data when the first key and the second key are the same.

According to one or more embodiment of this disclosure, a virtual machine backup system includes: a first host and a second host. The first host includes a virtual machine, a temporary storage area and a hard disk image file, wherein the virtual machine is connected to the temporary storage area, and the first host is configured to output a backup data set. The second host is connected to the first host, and is configured to receive the backup data set and generate a duplicate of the virtual machine and a duplicate of the hard disk image file. The first host is further configured to perform: capturing a request to write data from a virtual machine to the hard disk image file, wherein the request includes written data, input location information and output location information; copying the written data to the temporary storage area; calculating a first key of the written data; storing the first key, the input location information and the output location information into a first resource location structure; pausing an operation of the virtual machine and generating a second resource location structure according to the first resource location structure and a comparison result between the first key and a second key corresponding to the input location information, wherein the second key corresponds to existing data stored in the temporary storage area; and outputting the backup data set to the second host according to the second resource location structure for the second host to generate the duplicate of the virtual machine and the duplicate of the hard disk image file, wherein the backup data set includes the second resource location structure and only one of the existing data and the written data when the first key and the second key are the same.

In view of the above description, the virtual machine backup method system according to one or more embodiments of the present disclosure may capture operation data of the virtual machine in real time. By de-duplicating the written data, time and bandwidth required for transmitting the backup data set may be reduced, which may be improved to millisecond level. In addition, by the mechanism of capturing and temporarily storing the first key, the input location information and the output location information into the first resource location structure, when the first host has to pause the operation of the first virtual machine later on, the first host may not need to read data from the hard disk image file on the first hard disk again, and instead, the first host may use data in the first resource location structure and/or the first temporary storage area. Accordingly, the duration of pausing the first virtual machine to obtain the backup data set may be shortened. The virtual machine backup method system according to one or more embodiments of the present disclosure may be adapted to the backup of the virtual machine at local end or remote machine sites. Furthermore, when the remote machine site is in a low-bandwidth environment, a better target recovery point (RPO) may be presented to reduce data loss.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a virtual machine backup system according to an embodiment of the present disclosure;

FIG. 2 is a flowchart illustrating a virtual machine backup method according to an embodiment of the present disclosure;

FIG. 3 is a flowchart illustrating a virtual machine backup method according to another embodiment of the present disclosure; and

FIG. 4 is a flowchart illustrating a virtual machine backup method according to yet another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

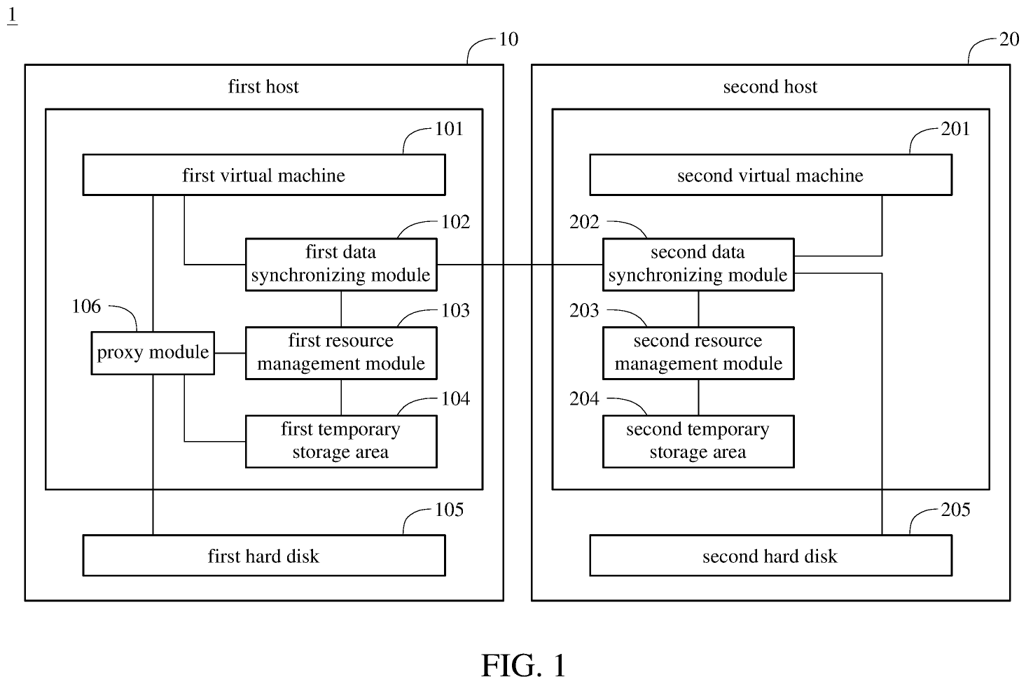

Please refer to FIG. 1, FIG. 1 is a block diagram illustrating a virtual machine backup system according to an embodiment of the present disclosure. As shown in FIG. 1, the virtual machine backup system 1 includes a first host 10 and a second host 20. The first host 10 and the second host 20 may each be a computer or a server. The first host 10 and the second host 20 may be connected to each other in a wired or wireless way, such as through Ethernet, local area network, Wifi, Bluetooth, mobile network, low-earth orbit satellite communication network, etc., the present disclosure does not limit the connection means between the first host 10 and the second host 20. The first host 10 may be a host running a first virtual machine 101, and the second host 20 may be a host for backing up the operating status of the first virtual machine 101. In other words, the first host 10 may be a computer or a server that the user is currently operating, and the second host 20 may be another computer or server. The second virtual machine 201 on the second host 20 is configured to execute the back up of the first virtual machine 101, which includes content in the memory, content in the hard disk image file and the status of the processor etc. of the first virtual machine 101. Therefore, when the first virtual machine 101 on the first host 10 stops operating due to failure or other reasons, the second virtual machine 201 on the second host 20 may restore the operating status of the first virtual machine 101 on the first host 10 before the first virtual machine 101 stop operating.

The first host 10 includes the first virtual machine 101, a first data synchronizing module 102, a first resource management module 103, a first temporary storage area 104, a first hard disk 105 and a proxy module 106. The first data synchronizing module 102, the first resource management module 103 and the proxy module 106 may be modules implemented by softwares, and these modules may be executed by a processor of a computer. The first temporary storage area 104 may be a storage block in the memory of the computer, and the first hard disk 105 may be a physical hard disk or a virtual hard disk in the computer. The first hard disk 105 may be configured to store a hard disk image file on the first host 10, and the proxy module 106 may be an input/output (I/O) proxy module. The first data synchronizing module 102 is connected between the first virtual machine 101 and the first resource management module 103. The first resource management module 103 is connected to the first temporary storage area 104 and the proxy module 106 and stores a first resource location structure. The first temporary storage area 104 is connected to the proxy module 106, and the proxy module 106 is further connected to the first hard disk 105. The functions of these modules are described below.

The second host 20 includes a second virtual machine 201, a second data synchronizing module 202, a second resource management module 203, a second temporary storage area 204 and a second hard disk 205. The second data synchronizing module 202 and the second resource management module 203 may be modules implemented by softwares, and these modules may be executed by a processor of a computer. The second temporary storage area 204 may be a storage block in the memory of the computer, and the second hard disk 205 may be a physical hard disk or a virtual hard disk in the computer. The second hard disk 205 may be configured to store a duplicate of the hard disk image file on the first host 10. The second data synchronizing module 202 is connected to the first data synchronizing module 102, the second virtual machine 201, the second resource management module 203 and the second hard disk 205, and the second resource management module 203 is connected to the second temporary storage area 204. The functions of these modules are described below.

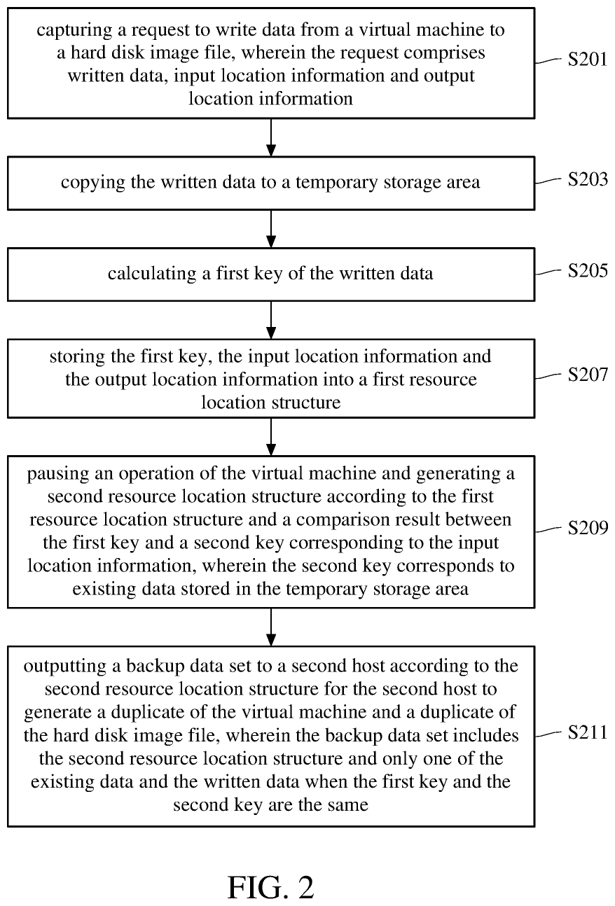

To further explain the operations of the first host 10 and the second host 20, please refer to FIG. 1 and FIG. 2, wherein FIG. 2 is a flowchart illustrating a virtual machine backup method according to an embodiment of the present disclosure. The virtual machine backup method according to an embodiment of the present disclosure is performed by the first host 10 and, as shown in FIG. 2, includes: step S201: capturing a request to write data from a virtual machine to a hard disk image file, wherein the request includes written data, input location information and output location information; step S203: copying the written data to a temporary storage area; step S205: calculating a first key of the written data; step S207: storing the first key, the input location information and the output location information into a first resource location structure; step S209: pausing an operation of the virtual machine and generating a second resource location structure according to the first resource location structure and a comparison result between the first key and a second key corresponding to the input location information, wherein the second key corresponds to existing data stored in the temporary storage area; and step S211: outputting a backup data set to a second host according to the second resource location structure for the second host to generate a duplicate of the virtual machine and a duplicate of the hard disk image file, wherein the backup data set includes the second resource location structure and only one of the existing data and the written data when the first key and the second key are the same.

When the virtual machine backup system 1 is activated, the latest duplicate of the virtual machine can be continuously established on the second host 20 through incremental background backup under hot backup mode. At this time, partial data will be backed up and sent speculatively in the background by the virtual machine backup system 1 at the first host 10. When the virtual machine backup system 1 determines that the duplicate of the virtual machine on the second host 20 needs to be updated, the virtual machine backup system 1 will pause the operation of the first host 10 to obtain internal data of the processor, memory status and hard disk status that are consistent with the current status of the first host 10. The virtual machine backup system 1 transmits all data obtained from the first host 10 (including the internal data of the processor, the memory status and the hard disk status) to the second host 20. The second host 20 receives said all data and restore the status of that time point (this action of obtaining the consistent status is referred to as a “check point”). To back up the request (referred to as “writing request” hereinafter) to write data to the first temporary storage area 104 for further processing, the proxy module 106 is used to proxy the writing of the hard disk image file from the first virtual machine 101 to the first hard disk 105. The proxy module 106 captures data content of the writing request and copies the data content to the first temporary storage area 104. Therefore, after the virtual machine backup system 1 establishes the check point, the virtual machine backup system 1 performs copying the writing request to the first hard disk 105. That is, in step S201, the proxy module 106 of the first host 10 captures the writing request from the first virtual machine 101 to the hard disk image file on the first hard disk 105, wherein the writing request at least includes written data, input location information and output location information. The written data is the data content that the first virtual machine 101 requests to write into the hard disk image file on the first hard disk 105. The input location information is the memory location of the first virtual machine 101 generating the written data. The output location information is the location or memory location offset that the first virtual machine 101 requests to write into the hard disk image file on the first hard disk 105. In short, the written data is the to-be-written data, the input location information is the source location of the written data, and the output location information is the target location of the written data or the offset of the written data at the hard disk image file.

In step S203, the proxy module 106 copies the written data to the first temporary storage area 104. Specifically, the first temporary storage area 104 may include a memory block and a hard disk image file block. The memory block is configured to temporarily store the input location information of the written data (for example, memory address), data size and data address; the hard disk image file block is configured to temporarily store the written data. The proxy module 106 may store the written data into the hard disk image file block of the first temporary storage area 104 in a sparse file format. Therefore, in the first temporary storage area 104, only the written data is allocated with storage space, the rest of the storage space of the hard disk image file block in the first temporary storage area 104 is an empty hole. Accordingly, memory space usage may be reduced. When the proxy module 106 stores the written data into the first temporary storage area 104, history written data in the hard disk image file block is overwritten. Therefore, when the first virtual machine 101 repeats writing to the same range of image file of the first hard disk 105, obsolete redundant data may be prevented from being recorded. In step S203, the proxy module 106 may write the written data into the hard disk image file on the first hard disk 105 at the same time. The first data synchronizing module 102 may store compressed memory modification content of the first virtual machine 101 into the first temporary storage area 104 and store a key corresponding to the memory modification content into the first temporary storage area 104. Through the buffering mechanism of step S203, when the virtual machine backup system 1 has to pause the first virtual machine 101 to ensure data consistency when establishing the check point, the virtual machine backup system 1 does not need to read data from the hard disk image file on the first hard disk 105 again; instead, the duplicate on the hard disk image file block of the first temporary storage area 104 may be used. Therefore, the process of pausing the first virtual machine 101 to obtain synchronizing data of the hard disk image file may be accelerated.

In step S205, the proxy module 106 maps the written data into fixed value to obtain the first key. For example, the proxy module 106 may perform hash calculation on the written data and use the generated hash value as the first key. The first key may be regarded as the identification number of the writing request for representing the written data, the input location information and the output location information.

The first resource management module 103 includes a de-duplicate submodule. In step S207, the first resource management module 103 receives the first key from the proxy module 106 and stores the first key, the input location information and the output location information into the first resource location structure. The first resource location structure may record a corresponding relationship between the input location information, the output location information and the key of each writing request. Specifically, the first resource location structure may be implemented in a key-value structure, such as a hash table, a binary tree etc., the present disclosure is not limited thereto. The first key, a second key and a third key described herein refer to the “key” in the key-value structure, and the written data, the input location information and the output location information may be regarded as the “value” in the key-value structure.

For better understanding, the following uses a table to exemplarily describes the first resource location structure. As shown in table 1 below, assuming that the writing request captured by the proxy module 106 includes first input location information and first output location information and the key that the writing request corresponds to is the first key, then the first resource management module 103 may fill the first input location information into “input location information” column, fill the first output location information into “output location information” column, and fill the first key into “key” column.

TABLE 1

| input location information | output location information | key |
|---|---|---|
| first input location | first output location | first key |
| information | information | |

The guest operating system in the first virtual machine 101 continues to modify the content in the memory and the hard disk image file in the first hard disk 105. Therefore, in step S209, the first host 10 needs to pause the operation of the first virtual machine 101 to store the final versions of the memory content, the hard disk image file in the first hard disk 105 and processor status etc. of this moment.

After pausing the operation of the first virtual machine 101, the de-duplicate submodule in the first resource management module 103 generates the second resource location structure according to the first resource location structure in the first resource management module 103 and the comparison result between the first key and the second key corresponding to the input location information. In detail, the second key is obtained by mapping the existing data in the first temporary storage area 104 into a fixed value, and the second key may be stored in the first temporary storage area 104, wherein the generation timing of the existing data is later than the timing of the first virtual machine 101 outputting the writing request. The existing data may be generated by the first data synchronizing module 102 of the first host 10 randomly or periodically by compressing raw data corresponding to the input location information. That is, the existing data may be generated by the first data synchronizing module 102 compressing raw data of the memory source location described above. In other words, the memory modification content stored into the first temporary storage area 104 described above may be used as the existing data.

The comparison result indicates that the first key and the second key are the same as or different from each other. Therefore, in step S209, the de-duplicate submodule in the first resource management module 103 generates the second resource location structure based on the comparison result and the first resource location structure, and the de-duplicate submodule may store the second resource location structure into the first resource management module 103. In other words, the first host 10 may use at least part of the first resource location structure as the second resource location structure, and said at least part of the first resource location structure includes the first key, the input location information and the output location information. By de-duplicating data of the first temporary storage area 104 in step S209, internet bandwidth usage may be reduced to achieve high immediacy where the synchronization efficiency may be improved to millisecond level.

In step S211, the first data synchronizing module 102 of the first host 10 outputs the backup data set to the second data synchronizing module 202 of the second host 20 according to the second resource location structure, such that the second host 20 generates the duplicate of the first virtual machine 101 and the duplicate of the hard disk image file on the first hard disk 105. When the first key and the second key are the same as each other, the backup data set includes the second resource location structure and only one of the existing data and the written data.

Specifically, please refer to step S209 and step S211, when the comparison result indicates that the first key and the second key are the same as each other, it means that the written data and the existing data are duplicate data. Therefore, the first resource management module 103 directly uses the first resource location structure as the second resource location structure, and the backup data set includes the existing data and does not include the written data. When the comparison result indicates that the first key and the second key are different from each other, it means that the written data and the existing data are different data.

Therefore, the first resource management module 103 removes the corresponding relationship between the input location information and the output location information from the first resource location structure to generate the second resource location structure.

Therefore, in step S211, the first data synchronizing module 102 reads the second resource location structure from the first resource management module 103. Further, if the first key and the second key are the same as each other, the first data synchronizing module 102 reads the existing data from the first temporary storage area 104 according to the second resource location structure. Then, the first data synchronizing module 102 outputs the backup data set to the second data synchronizing module 202 and does not output the written data, wherein the backup data set includes the second resource location structure and the existing data. In other words, when the first key and the second key are the same as each other, the information recorded in the to-be-sent second resource location structure is the hard disk address and memory address of the previously stored data, and the content of the duplicate data is skipped.

On the contrary, when the first key and the second key are different from each other, the first data synchronizing module 102 reads the existing data and the written data from the first temporary storage area 104 according to the second resource location structure, so that the backup data set includes the second resource location structure, the existing data and the written data, and the first data synchronizing module 102 outputs the backup data set to the second data synchronizing module 202.

In short, the backup data set may include data in the temporary storage area for hard disk synchronization and data in temporary storage area for memory synchronization that are not recorded with corresponding relationships in the second resource location structure and the second resource location structure.

In addition, “pausing the operation of the first virtual machine 101” described in step S209 may be pausing the operation of the first virtual machine 101 by the first host 10 in a constant frequency (for example, twice per second to 200 times per second); pausing the operation of the first virtual machine 101 by the first host 10 in a constant time interval; pausing the operation of the first virtual machine 101 by the first host 10 when time of the first virtual machine 101 being in idle status equals to or exceeds a time threshold; or pausing the operation of the first virtual machine 101 by the first host 10 when the first host 10 receives a user command requesting to pause the operation. Therefore, before step S209, the first host 10 may have already captured and stored the writing request for multiple times (for example, performing steps S201, S203, S205 and S207 for multiple times), and the first resource location structure may include a plurality of keys and a plurality of corresponding relationships of the input location information and the output location information (for example, table 1 has a plurality of rows of data), wherein the corresponding relationships correspond to a plurality of writing requests respectively. Therefore, the comparison between the keys described in step S209 may be performed on each one of the corresponding relationships in the first resource location structure. Since the memory modification content is stored by the first data synchronizing module 102, the proxy module 106 does not involve in the storage of the memory modification content and key calculation. Therefore, before the first host 10 pauses the operation of the first virtual machine 101 or when the first host 10 pauses the operation of the first virtual machine 101, the first data synchronizing module 102 of the first host 10 further obtains the memory modification data, and stores the memory modification data into the temporary storage area for memory synchronization. That is, the data stored into the temporary storage area for memory synchronization is the existing data.

After the second data synchronizing module 202 receives the backup data set, the second data synchronizing module 202 may store the second resource location structure of the backup data set into the second resource management module 203 and store data in the backup data set into the second temporary storage area 204. Therefore, the second data synchronizing module 202 may generate the duplicate of the first virtual machine 101 and the duplicate of the hard disk image file on the first hard disk 105 according to the second resource location structure in the second resource management module 203 and the data the second temporary storage area 204.

In addition, after step S211 (i.e. after the first data synchronizing module 102 outputs the backup data set to the second host 20), the first data synchronizing module 102 may notify the first resource management module 103 for the first resource management module 103 to reset the second resource location structure. That is, after outputting the backup data set to the second host 20, the first host 10 may remove all content from the second resource location structure.

In addition, also after step S211, the second data synchronizing module 202 of the second host 20 may send an acknowledge (ACK) signal to the first data synchronizing module 102 of the first host 10. The first data synchronizing module 102 may operate the first virtual machine 101 after triggered by the ACK signal, so that the first virtual machine 101 on the first host 10 may resume operation. Further, the second host 20 may also send the ACK signal to the first data synchronizing module 102 of the first host 10 after finishing the analysis on the backup data set, determining that the second resource location structure and the existing data/the written data in the backup data set conform to the system (for example, the second host 20) standard format and determining that the second temporary storage area 204 has raw data corresponding to the de-duplicated data (i.e. the written data). The de-duplicated data is data in the backup data set that is not repeated recorded.

It should be noted that, the first data synchronizing module 102 may output data in the order of storage address of the data. That is, the first data synchronizing module 102 may output data according to the sequence of storage spaces (for example, memory address from low to high) and not according to timing. For example, if the existing data of the first virtual machine 101 is sent before the corresponding written data in the first resource location structure and the second key of the existing data has not yet been calculated speculatively, or that the existing data is on a provisional list, then the first data synchronizing module 102 calculates the second key and transmits the existing data at the same time, for the comparison between the first key of the written data and the second key of the existing data to be performed when transmitting the written data subsequently.

On the contrary, if the written data of the first virtual machine 101 is sent prior to the corresponding existing data in the first resource location structure and if the existing data is not yet calculated by chance with a key which leads to an absent second key, then the first host 10 needs to calculate the second key before performing transmission, which causes the transfer of the first host 10 to be suspended. Therefore, to avoid the circumstance described above, the first data synchronizing module 102 may add the existing data corresponding to this written data into the provisional list to delay the transmission of the written data. When the second key of the existing data is calculated for said comparison, the transmission of the written data may be restored. At the same time, the first data synchronizing module 102 may transmit other written data to the second data synchronizing module 202.

In FIG. 2, step S203 is illustrated to be performed before step S205, but step S203 may also be performed after step S205, or step S203 and step S205 may be performed at the same time. In addition, step S209 is preferably performed after step S207.

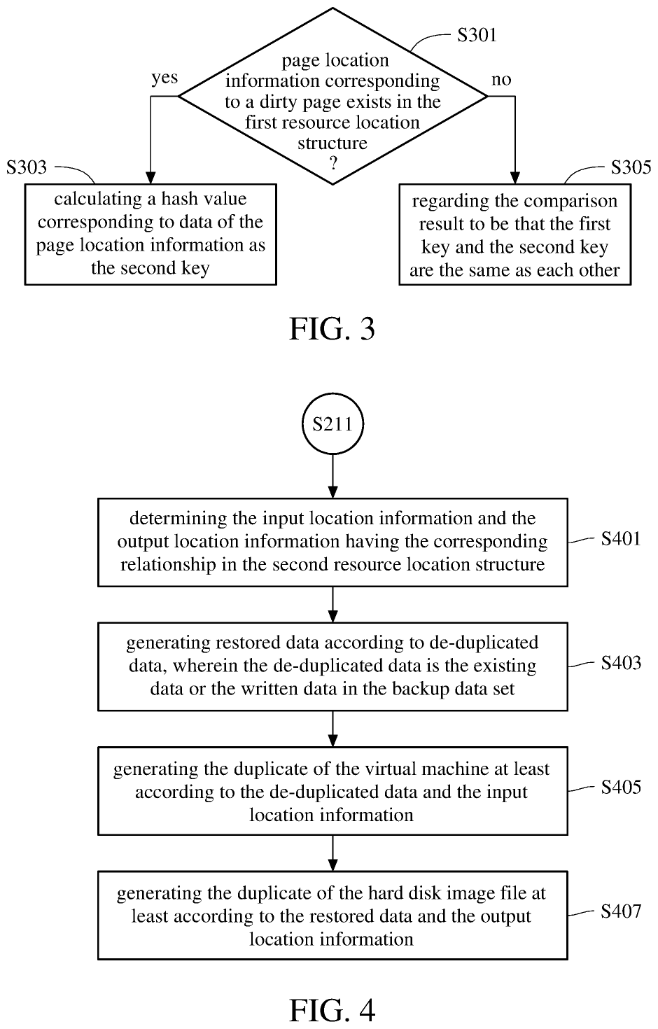

Please refer to FIG. 1 and FIG. 3, wherein FIG. 3 is a flowchart illustrating a virtual machine backup method according to another embodiment of the present disclosure. Steps S301, S303 and S305 shown in FIG. 3 may be performed in step S209 of FIG. 2. To be more specific, steps S301, S303 and S305 may be performed in pausing the operation of the first virtual machine 101 described in step S209. When the first host 10 pauses the operation of the first virtual machine 101, the first host 10 may further perform: step S301: determining whether page location information corresponding to a dirty page exists in the first resource location structure; if the determination result of step S301 is “yes”, performing step S303: calculating a hash value corresponding to data of the page location information as the second key; and if the determination result of step S301 is “no”, performing step S305: regarding the comparison result to be that the first key and the second key are the same as each other.

In step S301, the first resource management module 103 of the first host 10 determines whether the page location information corresponding to the dirty page exists in the first resource location structure. Specifically, to improve file access efficiency, operating system can use paging cache mechanism to map hard disk address in the first hard disk 105 to the memory space of the first virtual machine 101 corresponding to the input location information. Therefore, hard disk data in the first hard disk 105 and data in a part of the memory space are actually the same.

When the raw data in the memory space corresponding to the input location information is modified by the operating system of the first host 10 and the corresponding relationship between the key, the output location information and the input location information of the raw data exists in the first resource location structure, the input location information in the first resource location structure has said dirty page, and the memory address of the modified raw data is the page location information corresponding to the dirty page. It should be noted that the dirty page in the first resource location structure may be implemented with texts, symbols and other signs, the present disclosure is not limited thereto.

If the page location information corresponding to the dirty page exists the first resource location structure, then in step S303, the first host 10 maps the output location information, the input location information and the raw data of the page location information of the dirty page into a fixed value to obtain the third key, and uses the third key as the second key described above. On the contrary, if the page location information corresponding to the dirty page does not exist in the first resource location structure, then in step S305, the comparison result is considered to indicate that the first key and the second key are the same to generate the comparison result between the first key and the second key as described in step S209 of FIG. 2.

In addition, before determining whether the page location information corresponding to the dirty page exists in the first resource location structure, the proxy module 106 of the first host 10 may use the page location information of the first virtual machine 101 as the input location information. Therefore, the proxy module 106 may search the memory of the first virtual machine 101 according to the page location information, thereby finding the part in the memory of the first virtual machine 101 that matches the written data in a more efficient way.

Please refer to FIG. 1 and FIG. 4, wherein FIG. 4 is a flowchart illustrating a virtual machine backup method according to yet another embodiment of the present disclosure. In addition to steps shown in FIG. 2, after the first data synchronizing module 102 outputting the backup data set to the second data synchronizing module 202 (step S211 in FIG. 2), the virtual machine backup method of the present embodiment further includes, by the second host 20, performing: step S401: determining the input location information and the output location information having the corresponding relationship in the second resource location structure; step S403: generating restored data according to de-duplicated data, wherein the de-duplicated data is the existing data or the written data in the backup data set; step S405: generating the duplicate of the virtual machine at least according to the de-duplicated data and the input location information; and step S407: generating the duplicate of the hard disk image file at least according to the restored data and the output location information.

After receiving the backup data set, the second data synchronizing module 202 analyzes the backup data set, stores the second resource location structure in the backup data set into the second resource management module 203, and stores the existing data/the written data into the second temporary storage area 204 according to the second resource location structure in the backup data set. Therefore, in step S401, the second resource management module 203 may determine the input location information and the output location information in the second resource location structure having the corresponding relationship, wherein the corresponding relationship represents that the first key and the second key are the same.

After determining the input location information and the output location information having the corresponding relationship, in step S403, the second data synchronizing module 202 copies the existing data in the de-duplicated data to generate the restored data. In step S405, the second data synchronizing module 202 generates the duplicate of the memory modification data of the first virtual machine 101 according to the existing data in the de-duplicated data and the input location information, and writes the duplicate of the memory modification data of the first virtual machine 101 into the memory of the second virtual machine 201. In step S407, the second data synchronizing module 202 generates the duplicate of the modification data of the hard disk image file on the first hard disk 105 according to the restored data and the output location information, and writes the duplicate of the modification data of the hard disk image file on the first hard disk 105 into the second hard disk 205.

In short, in step S403, the second data synchronizing module 202 restores the existing data into the restored data according to the second resource location structure; in step S405, the second data synchronizing module 202 generates the duplicate of the first virtual machine 101 at least according to the existing data and the input location information and writes the duplicate of the first virtual machine 101 into the memory of the second virtual machine 201, for the second virtual machine 201 to restore the operating status of the first virtual machine 101; and in step S407, the second data synchronizing module 202 generates the duplicate of the hard disk image file on the first hard disk 105 at least according to the restored data and the output location information and writes the duplicate of the hard disk image file on the first hard disk 105 into the second hard disk 205, for the second hard disk 205 to restore the operating status of the first hard disk 105.

Further, when the backup data set includes other data (referred to as “remaining data” hereinafter) that is not recorded with the corresponding relationship in the second resource location structure, the second data synchronizing module 202 may generate the duplicate further according to the remaining data. Specifically, the second data synchronizing module 202 may generate a part of the duplicate of the first virtual machine 101 according to the remaining data corresponding to the temporary storage area for memory synchronization and generate the duplicate of the hard disk image file on the first hard disk 105 according to the remaining data corresponding to the temporary storage area for hard disk synchronization.

In addition, after the second host 20 receives the backup data set, the second virtual machine 201 may broadcast the new location of the first virtual machine 101 (i.e. location of the second virtual machine 201) to network(s) connected to the first host 10 by gratuitous address resolution protocol (ARP), such that ARP tables of other host(s) and/or network device(s) connected to the first host 10 may be updated to continue the operation of the first virtual machine 101 on the first host 10.

In FIG. 4, step S405 is illustrated to be performed before step S407, but step S405 may also be performed after step S407, or step S405 and step S407 may be performed at the same time.

When applied in practice, if the first virtual machine 101 stops operating and outputs the backup data set to the second host 20 but the second host 20 is unable to take on the network connection of the first host 10, the second host 20 may start timing to determine whether a timeout has occurred. When the second host 20 determines that a timeout has occurred, the second host 20 may take on the operation of the first virtual machine 101 based on the duplicate of the first virtual machine 101 and take on the operation of the first hard disk 105 based on the duplicate of the hard disk image file on the first hard disk 105.

Furthermore, the second host 20 may check on the status of the first host 10 during the transmission of the backup data set to avoid split-core (or referred to as “split-brain”) situation when the first virtual machine 101 and the second virtual machine 201 are in operation simultaneously. For example, the second host 20 may monitor the activity of the connection sent by the first host 10; the second host 20 and the first host 10 may share a temporary storage space, and the second host 20 may examine the communication condition with the first host 10 at the temporary storage space; or the second host 20 may examine the network connection between the second host 20 and the first host 10 through heartbeat mechanism.

Please refer to table 2 below, wherein table 2 shows evidence that the present disclosure may be used to improve synchronization efficiency and reduce the network bandwidth required to transmit backup data. In table 2, the virtual machine under database stress test (for example, TPC-C) is used as the first virtual machine 101 of FIG. 1, and the fixed time interval of the first host 10 pausing the operation of the first virtual machine 101 is set as 60 seconds.

As shown in table 2, comparing to known art, the virtual machine backup method system according to one or more embodiments of the present disclosure shows around 75% decrease in time spent on generating backup data and around 89% decrease in the size of the backup data. Therefore, it can be known from table 2 that the virtual machine backup method system according to one or more embodiments of the present disclosure effectively reduces time spent on generating backup data and bandwidth required for transmitting the backup data set.

TABLE 2

| | average time spent on | average size of |
|---|---|---|
| | generating backup data | backup data |
| | (millisecond) | (MB) |
| known art | 3403 | 2433 |
| present disclosure | 825 | 269 |

In view of the above description, the virtual machine backup method system according to one or more embodiments of the present disclosure may capture operation data of the virtual machine in real time. By de-duplicating the written data, time and bandwidth required for transmitting the backup data set may be reduced, which may be improved to millisecond level. In addition, by the mechanism of capturing and temporarily storing the first key, the input location information and the output location information into the first resource location structure, when the first host has to pause the operation of the first virtual machine later on, the first host may not need to read data from the hard disk image file on the first hard disk again, and instead, the first host may use data in the first resource location structure and/or the first temporary storage area. Accordingly, the duration of pausing the first virtual machine to obtain the backup data set may be shortened. The virtual machine backup method system according to one or more embodiments of the present disclosure may be adapted to the backup of the virtual machine at local end or remote machine sites. Furthermore, when the remote machine site is in a low-bandwidth environment, a better target recovery point (RPO) may be presented to reduce data loss. Moreover, by checking the status of the first host during the transmission of the backup data set, split-core (or split-brain) situation may be avoided.

What is claimed is:

1. A virtual machine backup method, performed by a first host, comprising:
capturing a request to write data from a virtual machine to a hard disk image file, wherein the request comprises written data, input location information and output location information;
copying the written data to a temporary storage area;
calculating a first key of the written data;
storing the first key, the input location information and the output location information into a first resource location structure;
pausing an operation of the virtual machine and generating a second resource location structure according to the first resource location structure and a comparison result between the first key and a second key corresponding to the input location information, wherein the second key corresponds to existing data stored in the temporary storage area; and
outputting a backup data set to a second host according to the second resource location structure for the second host to generate a duplicate of the virtual machine and a duplicate of the hard disk image file, wherein the backup data set comprises the second resource location structure and only one of the existing data and the written data when the first key and the second key are the same.

2. The virtual machine backup method according to claim 1, further comprising:
compressing, by the first host, raw data corresponding to the input location information to generate the existing data.

3. The virtual machine backup method according to claim 1, wherein copying the written data to the temporary storage area of the first host comprises:
storing the written data into the temporary storage area of the first host in a sparse file format.

4. The virtual machine backup method according to claim 1, further comprising when pausing the operation of the virtual machine, performing:
determining whether page location information corresponding to a dirty page exists in the first resource location structure; and
calculating a hash value corresponding to data of the page location information as the second key when the page location information corresponding to the dirty page exists in the first resource location structure.

5. The virtual machine backup method according to claim 4, further comprising before determining whether the page location information corresponding to the dirty page exists in the first resource location structure, performing:
using the page location information of the virtual machine as the input location information.

6. The virtual machine backup method according to claim 1, wherein the first resource location structure comprises a corresponding relationship between the input location information and the output location information, and the method further comprises:
removing the corresponding relationship between the input location information and the output location information from the first resource location structure to generate the second resource location structure when the first key and the second key are different, wherein the backup data set comprises the second resource location structure, the existing data and the written data.

7. The virtual machine backup method according to claim 1, wherein the virtual machine is a first virtual machine, the temporary storage area is a first temporary storage area, and the method further comprises after outputting the backup data set to the second host, by the second host, performing:
generating restored data according to de-duplicated data when the second resource location structure comprises a corresponding relationship between the input location information and the output location information, wherein the de-duplicated data is the existing data or the written data in the backup data set;
generating the duplicate of the virtual machine at least according to the de-duplicated data and the input location information; and
generating the duplicate of the hard disk image file at least according to the restored data and the output location information.

8. The virtual machine backup method according to claim 1, further comprising after outputting the backup data set to the second host, performing:
operating the virtual machine by the first host when triggered by an acknowledge signal output by the second host.

9. The virtual machine backup method according to claim 1, further comprising after outputting the backup data set to the second host, performing: resetting the second resource location structure.

10. A virtual machine backup system comprising:
a first host comprising a virtual machine, a temporary storage area and a hard disk image file, wherein the virtual machine is connected to the temporary storage area, and the first host is configured to output a backup data set; and
a second host connected to the first host, and configured to receive the backup data set and generate a duplicate of the virtual machine and a duplicate of the hard disk image file,
wherein the first host is further configured to perform:
capturing a request to write data from the virtual machine to the hard disk image file, wherein the request comprises written data, input location information and output location information;
copying the written data to the temporary storage area;
calculating a first key of the written data;
storing the first key, the input location information and the output location information into a first resource location structure;
pausing an operation of the virtual machine and generating a second resource location structure according to the first resource location structure and a comparison result between the first key and a second key corresponding to the input location information, wherein the second key corresponds to existing data stored in the temporary storage area; and
outputting the backup data set to the second host according to the second resource location structure for the second host to generate the duplicate of the virtual machine and the duplicate of the hard disk image file, wherein the backup data set comprises the second resource location structure and only one of the existing data and the written data when the first key and the second key are the same.

11. The virtual machine backup system according to claim 10, wherein the first host is further configured to compress raw data corresponding to the input location information to generate the existing data.

12. The virtual machine backup system according to claim 10, wherein the first host performing copying the written data to the temporary storage area of the first host comprises:
storing the written data into the temporary storage area of the first host in a sparse file format.

13. The virtual machine backup system according to claim 10, wherein when pausing the operation of the virtual machine, the first host is further configured to perform:
determining whether page location information corresponding to a dirty page exists in the first resource location structure; and
calculating a hash value corresponding to data of the page location information as the second key when the page location information corresponding to the dirty page exists in the first resource location structure.

14. The virtual machine backup system according to claim 13, wherein before determining whether the page location information corresponding to the dirty page exists in the first resource location structure, the first host is further configured to use the page location information of the virtual machine as the input location information.

15. The virtual machine backup system according to claim 10, wherein the first resource location structure comprises a corresponding relationship between the input location information and the output location information, and the first host is further configured to perform:
removing the corresponding relationship between the input location information and the output location information from the first resource location structure to generate the second resource location structure when the first key and the second key are different, wherein the backup data set comprises the second resource location structure, the existing data and the written data.

16. The virtual machine backup system according to claim 10, wherein the virtual machine is a first virtual machine, the temporary storage area is a first temporary storage area, and after the second host receives the backup data set, the second host is further configured to perform:
generating restored data according to de-duplicated data when the second resource location structure comprises a corresponding relationship between the input location information and the output location information, wherein the de-duplicated data is the existing data or the written data in the backup data set;
generating the duplicate of the virtual machine at least according to the de-duplicated data and the input location information; and
generating the duplicate of the hard disk image file at least according to the restored data and the output location information.

17. The virtual machine backup system according to claim 10, wherein after the second host receives the backup data set, the second host is further configured to perform:
operating the virtual machine by the first host when triggered by an acknowledge signal output by the second host.

18. The virtual machine backup system according to claim 10, wherein after the first host outputs the backup data set to the second host, the first host is further configured to reset the second resource location structure.
